(19) United States
(12) Patent Application Publication
(10) Pub. No.: US 2026/0244377 A1
(43) Pub. Date: Aug. 20, 2026

(54) ELECTRONIC DEVICE PREPARING SETTING DATASETS BY INPUTTING SPECIFIC DATA TO TRAINED MACHINE LEARNING MODEL

(71) Applicant: BROTHER KOGYO KABUSHIKI KAISHA, Nagoya (JP)

(72) Inventor: Sho Ogura, Nagoya (JP)

(21) Appl. No.: 19/170,310

(22) Filed: Apr. 4, 2025

(30) Foreign Application Priority Data
Apr. 22, 2024 (JP) 2024-069061

(51) Int. Cl. G06F 3/12

(52) U.S. Cl. CPC G06F 3/1231; G06F 3/1205; G06F 3/1256

(57) ABSTRACT

A controller of an electronic device inputs, to a trained model, first input data, second input data, and specific data. The first input data specifies an element relationship among elements including first and second subjects. The second input data specifies a first condition for settings for the first subjects. The specific data is data instructing the trained model to return output data satisfying a second condition. The second condition includes a requirement that the output data includes recommended setting datasets and a subject-setting relationship both based on the first and second input data, and a requirement that the subject-setting relationship indicates that each second subject corresponds to one recommended setting dataset. The controller stores the received recommended setting datasets for second subjects based on the subject-setting relationship. The controller performs processing for each second subject in accordance with a corresponding setting dataset.

### REFERENCE TO RELATED APPLICATIONS

This application claims priority from Japanese Patent Application No. 2024-069061 filed on Apr. 22, 2024. The entire content of the priority application is incorporated herein by reference.

### BACKGROUND ART

In recent years, conventional printers have been provided with a plurality of functions, such as a copy function, a print function, a scan function, and a facsimile function. A technology known for use with such multifunction printers identifies users and sets the availability of each function for each user.

### SUMMARY

When an administrator or user of the printer or other electronic devices needs to input values for a plurality of settings into the device, such input operations are time-consuming.

In view of the foregoing, it is an object of the present disclosure to provide an electronic device to set the plurality of settings without requiring the administrator or user to perform cumbersome operations.

In order to attain the above and other objects, the present disclosure provides an electronic device. The electronic device includes a user interface, a communication interface, a memory, and a controller. The controller is configured to perform: receiving first input data and second input data through the user interface, the first input data being in a first format interpretable by a trained machine learning model running on a server, the first input data specifying an element relationship among a plurality of elements, the plurality of elements including one or more first subjects and one or more second subjects, the second input data being in a second format interpretable by the trained machine learning model, the second input data specifying a first condition for one or more settings for the one or more first subjects; inputting, to the trained machine learning model through the communication interface, the first input data, the second input data, and specific data, wherein the specific data is data instructing the trained machine learning model to return output data satisfying a second condition, the second condition including: a requirement that the output data is in a third format interpretable by the controller; a requirement that the output data includes one or more recommended setting datasets based on both the first input data and the second input data, and includes a subject-setting relationship based on both the first input data and the second input data; and a requirement that the subject-setting relationship indicates that each of the one or more second subjects corresponds to one of the one or more recommended setting datasets; storing, when the output data is received in response to performing the inputting, the one or more recommended setting datasets in the memory as one or more setting datasets so that each of the one or more second subjects is associated with a corresponding one of the one or more recommended setting datasets based on the subject-setting relationship included in the output data; and processing for each of the one or more second subjects in accordance with a corresponding setting dataset associated with the each of the one or more second subjects among the one or more setting datasets stored in the memory.

In the above structure, the time and effort required for the administrator or user to input setting datasets for subjects.

### BRIEF DESCRIPTION OF DRAWINGS

FIG. 1 is an explanatory diagram illustrating an overview of a system configuration according to an embodiment of the present disclosure.

FIG. 2 is a flowchart illustrating an example of a settings information reception process.

FIG. 3 is an explanatory diagram illustrating an example of a screen having an entry field for receiving input for configuring functional restrictions.

FIG. 4 is an explanatory diagram illustrating an example of a screen having an entry field for receiving input for configuring a user list.

FIG. 5 is a flowchart illustrating an example of a settings support process.

FIG. 6 is an explanatory diagram illustrating an example of a data entry screen.

FIG. 7 is an explanatory diagram illustrating an example of an organizational structure information.

FIG. 8 is a flowchart illustrating an example of a settings confirmation process.

FIG. 9 is an explanatory diagram illustrating an example of a preview screen.

FIG. 10 is a flowchart illustrating an example of a settings support process.

### DESCRIPTION

Below, an electronic device according to a first embodiment of the disclosure will be described in detail while referring to the accompanying drawings. The following specification discloses a multifunction peripheral (hereinafter “MFP”) having various functions including image formation functions.

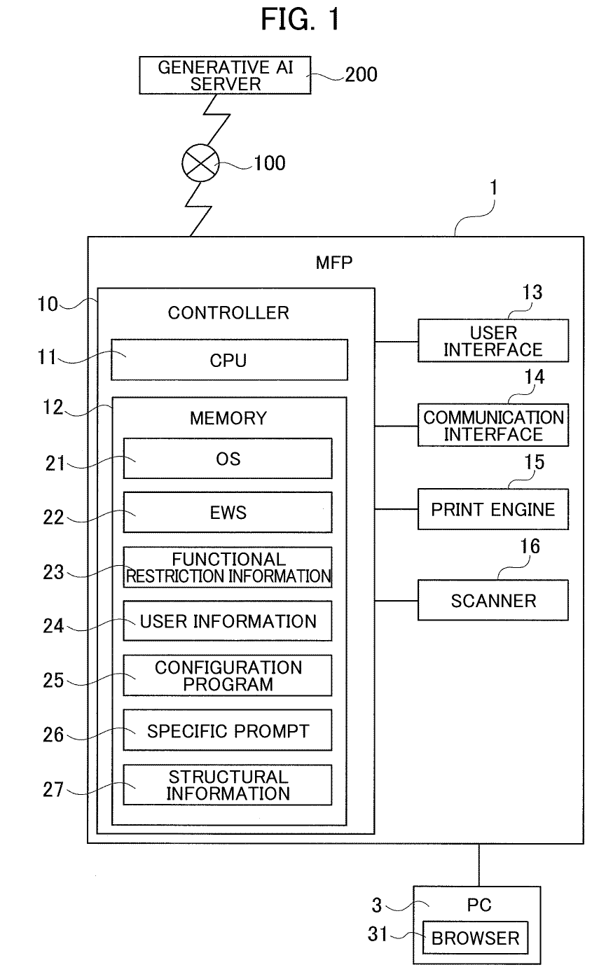

FIG. 1 shows an example of an MFP 1 according to this embodiment. As shown in FIG. 1, the MFP 1 is provided with a controller 10 that includes a CPU 11 and a memory 12. The MFP 1 is also provided with a user interface 13, a communication interface 14, a print engine 15, and a scanner 16, all of which are electrically connected to the controller 10. As examples of image formation, the print engine 15 can print images, and the scanner 16 can read images. The MFP 1 is an example of an electronic device. The print engine 15 and the scanner 16 are examples of the image formation engine.

The CPU 11 of the MFP 1 executes various processes according to programs read from the memory 12 and/or based on user operations. The memory 12 of the MFP 1 stores various programs and data, including an operating system (hereinafter “OS”) 21, a program and data for implementing an Embedded Web Server function (hereinafter “EWS”) 22, functional restriction information 23, user information 24, and a configuration program 25. The MFP 1 can also store a specific prompt 26, and structural information 27. The memory 12 is used as a work area when executing various processes. A buffer provided in the CPU 11 is an example of memory 12. The programs and data will be described later in greater detail.

Examples of the memory 12 may include ROM, RAM, a hard disk drive, or the like built into the MFP 1, or may be a storage medium that is readable and writable by the CPU 11. A computer-readable storage medium is a non-transitory medium. In addition to the above examples, non-transitory media include CD-ROM and DVD-ROM. A non-transitory medium is also a tangible medium. On the other hand, electric signals that convey programs downloaded from a server or the like on the Internet are a computer-readable signal medium, which is one type of computer-readable medium but is not considered a non-transitory, computer-readable storage medium.

The user interface 13 includes hardware for displaying screens that report information to the user, and hardware for receiving operations by the user. The user interface 13 may include a touchscreen having a function for displaying screens and a function for receiving operations, or may include a combination of a display, hardware buttons, and the like.

The communication interface 14 includes hardware for communicating with external devices. The communication interface 14 includes functions supporting such communication standards as Wi-Fi (U.S. trademark of Wi-Fi Alliance CORPORATION), Ethernet, and Universal Serial Bus (USB). The communication interface 14 may be a network interface.

The MFP 1 can connect to a personal computer (hereinafter abbreviated to “PC”) 3 through a wired or wireless local area network (LAN) or the like. The PC 3 is provided with a browser 31 through which the PC 3 can access the EWS 22 of the MFP 1. When the EWS 22 of the MFP 1 is accessed by the PC 3, the MFP 1 can transmit HTML data to the PC 3 for displaying images on the browser 31. While images are displayed on the browser 31 based on HTML data received from the EWS 22 of the MFP 1, the PC 3 can accept user operations and can transmit data representing the received operations to the MFP 1. When the MFP 1 receives data specifying operations from the PC 3 via the browser 31, the MFP 1 can execute processes based on those operations. In this case, the EWS 22 providing the HTML data is an example of the user interface of the MFP 1.

The MFP 1 can also connect to an internet 100 via the communication interface 14 and can access a generative AI server 200 via the internet 100. A trained model stored on the generative AI server 200 is a machine learning model that has been pre-trained using various data to generate output data based on inputted data. The generative AI server 200 is also provided with a chat function. When a question is inputted into the chat function, the generative AI server 200 can generate a response to the inputted question using the trained model and can output this response to the device that inputted the question. The following example illustrates a question (hereinafter referred to as a “prompt”) in English, but the language used in the prompt is not limited to English. The generative AI server 200 may be a server embedded with OpenAI's ChatGPT, for example. The generative AI server 200 is an example of the server storing the trained machine learning model.

In this embodiment, the MFP 1 is shared by a plurality of users. The MFP 1 can store information on multiple users allowed to use the MFP 1 as the user information 24 and can perform login authentication using the user information 24 when a login instruction is received. The MFP 1 can configure a plurality of groups to which individual users belong and can store information on the group to which each user belongs as part of the user information 24.

The MFP 1 according to the present embodiment has a plurality of image formation functions including functions for printing, copying, scanning, sending and receiving faxes, and uploading and downloading data via a cloud connection. The MFP 1 can receive functional restriction settings to restrict the use of some functions for individual users. Specifically, the MFP 1 can store settings indicating the availability of each of the plurality of image formation functions for each group to which users belong as the functional restriction information 23.

With this configuration, when the MFP 1 receives a login instruction from a user and login authentication is successful, the MFP 1 can identify the group to which this login user belongs based on the user information 24 and can acquire settings established for that group based on the functional restriction information 23. The MFP 1 is then configured to perform operations in accordance with the acquired settings. For example, when information indicating that printing is available but scanning is not available has been stored for the group to which the current login user belongs, the MFP 1 enables operations for printing by the logged-in user but disables operations for scanning.

Next, steps in a settings information reception process that can be executed on the MFP 1 will be described. The process steps described below essentially indicate processes performed by the CPU 11 in accordance with commands described in programs. In other words, process steps in the following description using action verbs such as “determine,” “extract,” “select,” “calculate,” “set,” “identify,” “acquire,” “receive,” and “control” represent processes of the CPU. Processes performed by the CPU include hardware control using the API in the OS. However, this specification describes operations of each program while omitting the role of the OS. That is, a statement in the following description to the effect that “Program B controls Hardware C” may signify that “Program B controls Hardware C using the API of the OS.” Further, a process of the CPU performed according to an instruction described in a program may be described using abbreviated expressions, such as “the CPU executes.” Similarly, a process executed by the CPU according to instructions described in a program may be described using expressions that omit the CPU, such as “Program A executes.”

Note that the term “acquire” is used as a concept that does not necessarily require a request. In other words, a process by which the CPU receives data without requesting that data is included in the concept of “the CPU acquires data.” Further, the term “data” described herein is expressed in bit strings that can be read by a computer. Data of different formats are treated as the same data when the content of the data is essentially the same. The same holds true for “information” in this specification. Further, the terms “requesting” and “instructing” are concepts that denote outputting information to another device indicating a request and an instruction, respectively. Further, information indicating a request and information indicating an instruction will simply be described as a “request” and an “instruction,” respectively.

Further, a process performed by the CPU to determine whether Information A indicates Circumstance B may be described conceptually as “determining whether Circumstance B based on Information A.” A process in which the CPU determine whether Information A indicates Circumstance B or Circumstance C may be described conceptually as “determining whether Circumstance B or Circumstance C based on Information A.”

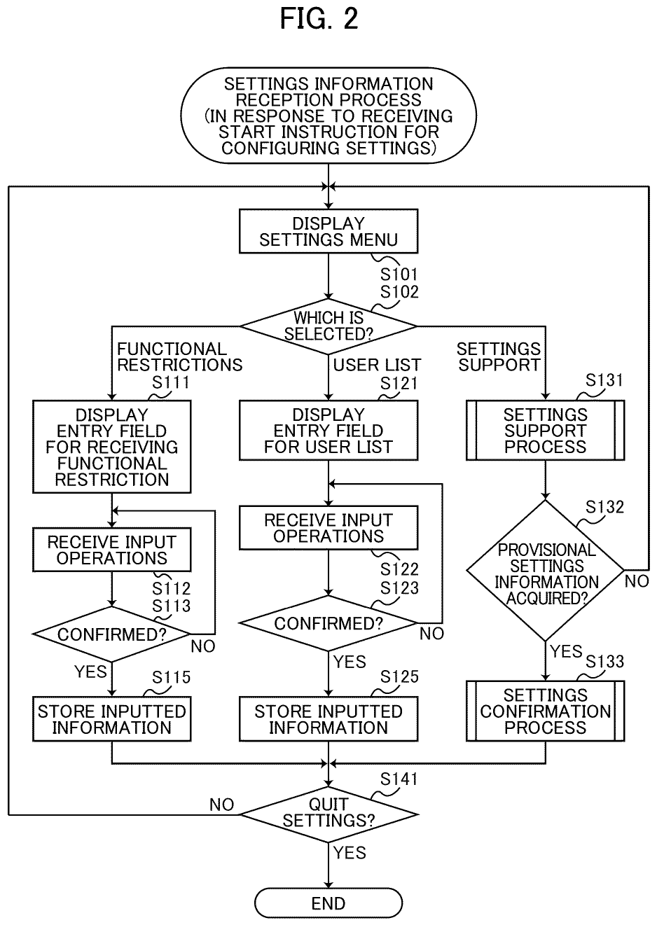

Next, steps in a settings information reception process executed on the MFP 1 will be described with reference to the flowchart in FIG. 2. The CPU 11 of the MFP 1 executes the settings information reception process upon receiving a start instruction for configuring various settings on the MFP 1. The following description will cover settings related to functional restrictions while omitting the other various settings configured on the MFP 1. The following content described as displays and operations on the user interface 13 may instead be displays and operations performed by the EWS 22 via the browser 31 of the PC 3, as described above.

Note that the MFP 1 may be configured to receive settings for restricting functions only after a user with administrative privileges has logged in to the MFP 1. The following description will assume that the user who issued the start instruction to begin the settings information reception process and who performs settings-related operations is the “administrator,” and the plurality of users who use the MFP 1 after settings have been configured are “users.”

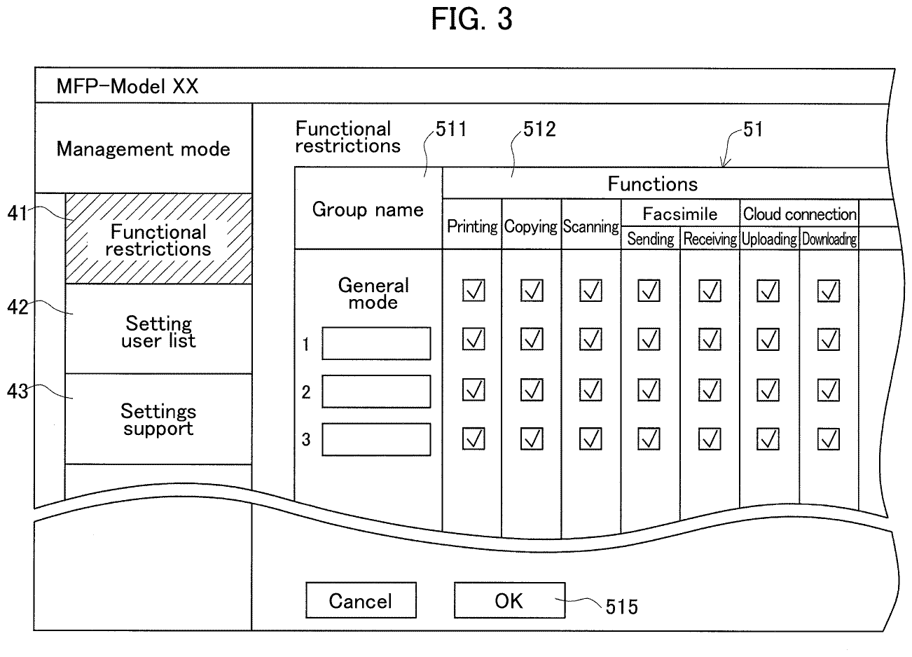

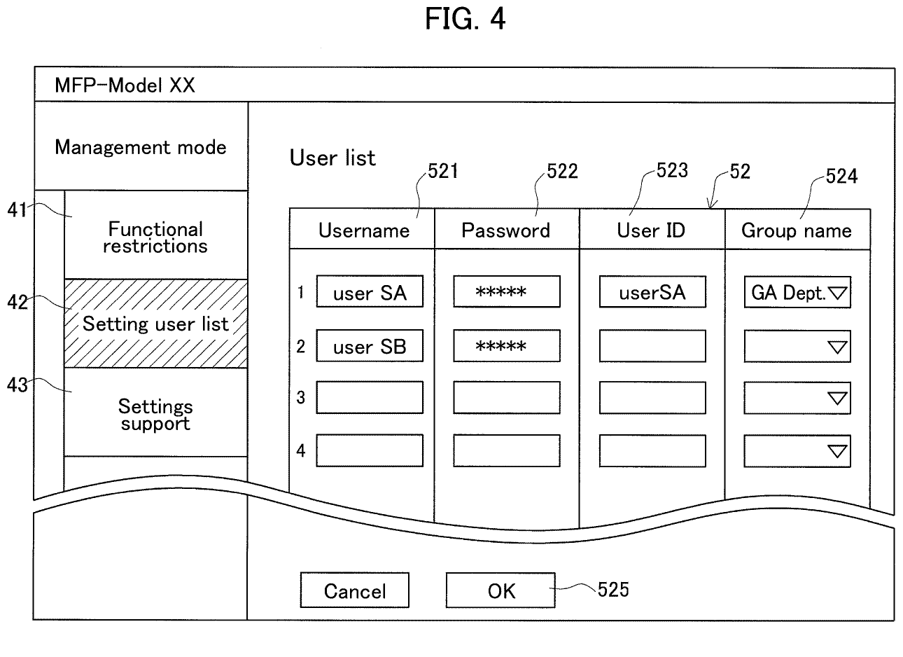

In response to receiving an instruction to configure settings, in S101 the CPU 11 displays a settings menu that includes an option for configuring functional restrictions on the user interface 13, and in S102 accepts a selection from the administrator via the user interface 13. In the example shown in FIG. 3, the settings menu includes a functional restrictions button 41 to receive an instruction to display a screen having an entry field 51 to configure functional restrictions, a user list button 42 to receive an instruction to display a screen having an entry field 52 (FIG. 4) to register or edit users in the user list, and a settings support button 43 that accepts an instruction for settings support. Through the settings menu, the CPU 11 can accept various settings in addition to settings related to functional restrictions. In S101 the CPU 11 displays a screen that includes an initial image of the settings menu without the entry field 51 described later.

When the CPU 11 determines in S102 that an operation has been received from the administrator on the functional restrictions button 41 in the settings menu (S102: functional restrictions), in S111 the CPU 11 displays an entry field 51 on the user interface 13 for receiving the input of information to be stored in the functional restriction information 23, as illustrated in the example of FIG. 3. In this example, the CPU 11 displays a group name field 511 in association with a functional information field 512 in the entry field 51.

The group name field 511 receives input for names specifying individual groups when a plurality of users is sorted into a plurality of groups. The group names inputted into the group name field 511 are set arbitrarily by the administrator. For example, group names may be the names of the departments to which users belong, such as the General Affairs Department (GA Dept.), the Development Department (Dev Dept.), and the Sales Department (Sales Dept.); the types of employment status, such as executives, full-time employees, and part-time workers; or classification names for classifying users according to seniority, qualifications, and the like. “General Mode” in the group name field 511 denotes a mode that requires no authentication and is available to any user. Thus, the MFP 1 treats any user who is not logged in as a “General Mode” user.

The functional information field 512 receives inputted settings for each group specified in the group name field 511. The settings are information indicating the availability of each of the plurality of image formation functions possessed by the MFP 1 for the group in question. Specifically, the functional information field 512 has an item corresponding to each function of the MFP 1 and a checkbox for each item. That is, each item indicates a category of a parameter, and the state of the corresponding checkbox determines a setting value assigned to that parameter. The information received in each checkbox indicates the availability of that item. Items that can be provided in the functional information field 512 may include the image formation functions described above, such as print, copy, and scan; as well as restrictions on the number of printable sheets; restrictions on color printing and monochrome printing, respectively; and restrictions on default values for print settings and the like. FIG. 3 shows an example of the entry field 51 in its initial state in which all group names are blank and all items are available.

In S112 of FIG. 2, the CPU 11 receives input operations in the group name field 511 and functional information field 512. When entering the information manually, the administrator must input the name of each group in the group name field 511 and must check or uncheck the checkbox for each item in the functional information field 512 for that group. The process of S112 is an example of the setting reception process.

In S113 the CPU 11 determines whether an operation to accept the information inputted in the entry field 51 has been received. For example, the CPU 11 determines that an operation to accept the information has been received when the administrator operates an OK button 515 displayed on the user interface 13. When the CPU 11 determines that an operation to accept the inputted information has been received (S113: YES), in S115 the CPU 11 stores the information displayed in the entry field 51 in the memory 12 as the functional restriction information 23 (see FIG. 1). That is, the CPU 11 stores information specifying each group name that has been inputted into the group name field 511 in association with information representing the functional restriction settings indicated by the presence or absence of a checkmark for each item in the functional information field 512. When the CPU 11 determines that no operation to accept the inputted information has been received (S113: NO), the CPU 11 returns to S112 to wait for the operation. The confirmation operation to accept the inputted information received in S113 is an example of the setting instruction.

After configuring the functional restriction information 23 through operations in the entry field 51, the administrator performs an operation on the user list button 42 shown in FIG. 3, for example. When the CPU 11 determines that an administrator operation on the user list button 42 has been received in the settings menu (S102: user list), in S121 the CPU 11 displays an entry field 52 on the user interface 13, as illustrated in FIG. 4. The entry field 52 is provided for receiving information on each user stored in the user information 24. For example, the CPU 11 displays an entry field 52 having a username field 521, a password field 522, a user ID field 523, and a group name field 524 for receiving input of a username, a password, and a user ID, and a group to be associated with each user.

The username field 521 and password field 522 receive information that will be used in the login authentication for that user. The user ID field 523 receives identification information that identifies the user. The group name field 524 receives information specifying the group to which the user belongs and is specifically one of the group names received in the group name field 511 of the entry field 51 described above (see FIG. 3). The CPU 11 may display each group name that has been inputted into the group name field 511 in the group name field 524 as an option in a pull-down menu, for example, and may receive a group designation when the administrator makes a selection from among those options.

In S122 the CPU 11 receives input operations in each field of the entry field 52. In the example of FIG. 4, the administrator inputs the username “User SA,” inputs a password and user ID associated with “User SA,” and inputs “General Affairs Department” as the group name indicating the department to which the user identified by “User SA” belongs. The administrator similarly inputs the username “User SB.” In the example of FIG. 4, the administrator is still in the process of entering information for “User SB” and has not yet inputted a user ID or group name. When entering information manually in this way, the administrator must enter information in the username field 521, password field 522, and user ID field 523 and select a group name in the group name field 524 for each user. The process of S122 is an example of the setting reception process.

In S123 the CPU 11 determines whether an operation for accepting the information entered in the entry field 52 has been received. For example, the CPU 11 determines that an operation for accepting the inputted information has been received when the administrator performs an operation on an OK button 525. When the CPU 11 determines that an operation to accept the inputted information has been received (S123: YES), in S125 the CPU 11 stores the information received in the entry field 52 in the memory 12 as the user information 24 (see FIG. 1). At minimum, the CPU 11 associates each user identified by the combination of a username and password inputted into the username field 521 and password field 522 with a group name received in the group name field 524 and stores this association as the user information 24. When the CPU 11 determines that no operation to accept the inputted information has been received (S123: NO), the CPU 11 returns to S122 to wait for the operation. The confirmation operation to accept the inputted information received in S123 is an example of the setting instruction.

By storing the functional restriction information 23 and user information 24 in the memory 12 in this way, the administrator of the MFP 1 can configure settings for each user indicating whether each of the various functions of the MFP 1 is available to that user. Since the MFP 1 can receive settings by group, the MFP 1 can store settings for users through the group to which they belong, even when there is a large number of users. The user is an example of the first subject. The processes of S115 and S125 are examples of the manual setting process.

However, the burden on the administrator for inputting this information is great, particularly when the organization is large and has many users and groups, because of the large amount of information to be entered. Here, the MFP 1 may possess a function for reading the information to be entered into each of the input fields shown in FIGS. 3 and 4 from a CSV file or the like prepared by the administrator. However, this still requires the administrator to write the information to be inputted into each input field in the file, placing a great burden on the administrator.

The CPU 11 may also be capable of accepting an instruction to cancel operations performed in the entry field 51 and entry field 52. Further, although the administrator first performs operations to set the functional restriction information 23 and then performs operations to set the user information 24 in the above example, these operations may be performed in the reverse order.

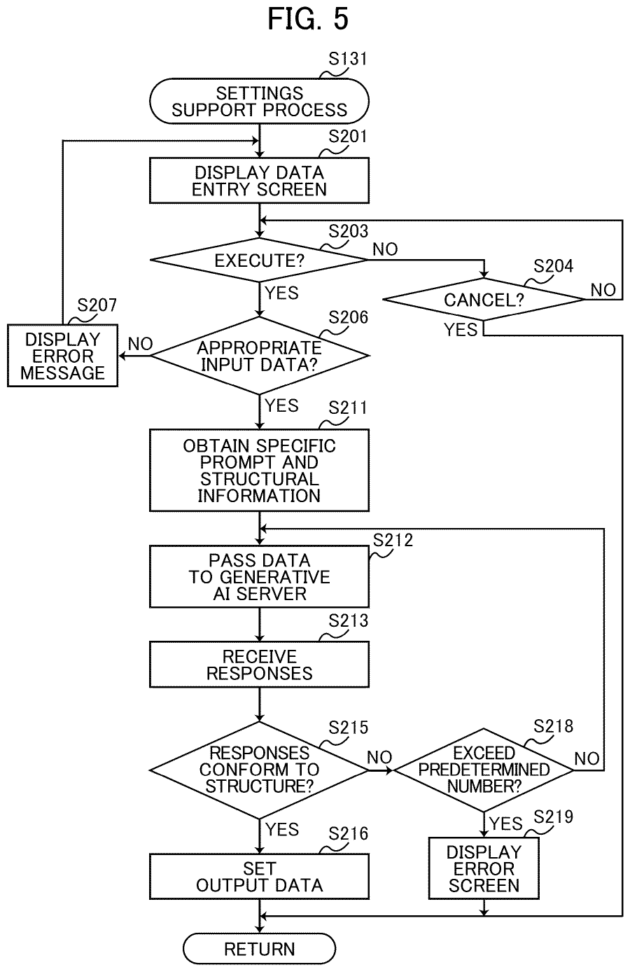

Further, when the CPU 11 determines in S102 that an operation on the settings support button 43 has been received from the administrator in the settings menu displayed in S101 (S102: settings support), in S131 the CPU 11 executes a settings support process. Steps in the settings support process will be described next with reference to the flowchart shown in FIG. 5.

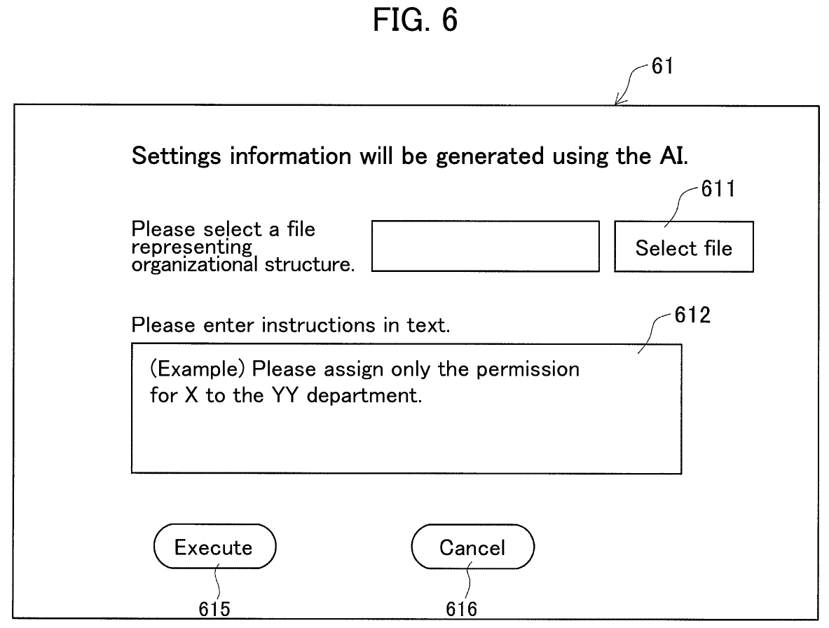

In S201 the CPU 11 displays a data entry screen for settings support on the user interface 13 and receives input from the administrator. FIG. 6 shows an example of a data entry screen 61 displayed by the CPU 11. The data entry screen 61 includes a first input button 611 that receives the input of organizational structure information, a second input field 612 that receives the input of a prompt, an Execute button 615, and a Cancel button 616. The process of S201 is an example of the input data reception process.

The first input button 611 receives a selection of data indicating organizational structure information. Data specifying organizational structure information includes information defining relationships between the username of each user using the MFP 1 and the group name of the group to which the user belongs. These relationships between usernames and group names are illustrated in a diagram or table. The usernames and group names are examples of data indicating elements and examples of data indicating subjects, and the information specifying groups to which each user belongs is an example of data indicating relationships among elements. Data received from a selection through the first input button 611 is an example of the first input data.

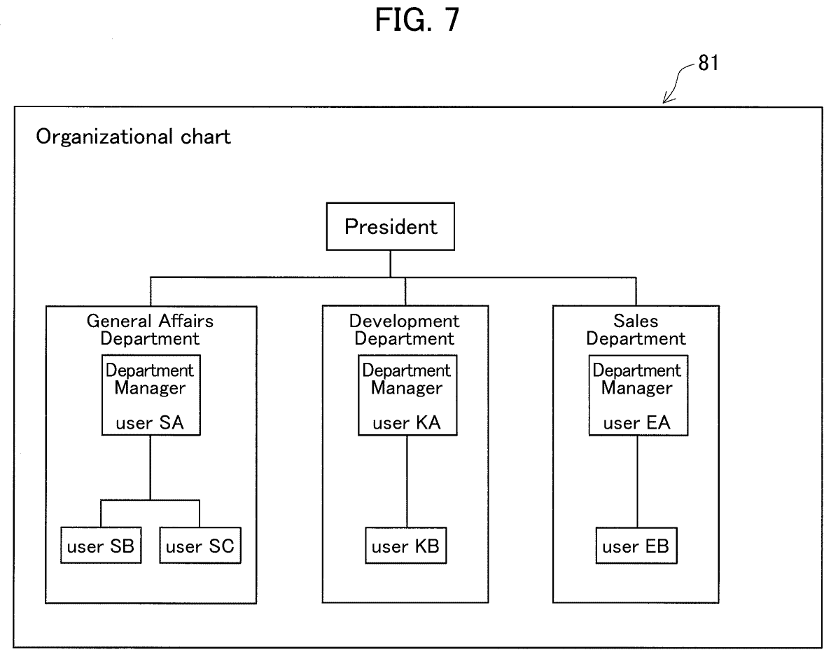

When the group name is the name of the department to which the user belongs, such as the “General Affairs Department,” “Development Department,” or “Sales Department,” the administrator can select image data representing an image showing the association among each department name and the username of each user (e.g., “User SA”), as illustrated in an image 81 of FIG. 7, as the data specifying organizational structure information. The organizational structure information shown in FIG. 7 has a hierarchical structure that includes the group names, and the usernames of users belonging to each group. The organizational structure information is an example of the hierarchical structure data defining the hierarchical structure. The group names are examples of first-level elements, and the usernames are examples of second-level elements subordinate to the first level.

The input data received from the selection through the first input button 611 is inputted into the trained model of the generative AI server 200 in a later step. The trained model of the generative AI server 200 may be capable of analyzing image data to interpret what meaning the image data has. In this case, the trained model can interpret that the inputted image data is an organization chart for an organization including a plurality of groups with the usernames of users belonging to each group. The trained model of the generative AI server 200 may also be capable of analyzing data containing textual information to interpret what kind of meaning the data has. In this case, the trained model can interpret that the data containing textual information describing information equivalent to that in FIG. 7 is textual information specifying an organization including a plurality of groups with the usernames of users belonging to each group.

The format of image data selected with the first input button 611 may be JPEG, PNG, GIF, PDF, and the like. Further, the format of the data containing textual information selected with the first input button 611 may be PDF, CSV, XLS, or an unstructured format such as text providing a description of the organization in written form. A prompt is another example of data that can contain textual information in an unstructured format.

Further, the input data selected through the first input button 611 may contain information on all users subject to the settings or may contain information on just some of the users subject to the settings. For example, the input data may be image data representing only the General Affairs Department among the information shown in FIG. 7. The CPU 11 may also be capable of receiving a plurality of selections for input data through the first input button 611. For example, when image data representing only the General Affairs Department, image data representing only the Development Department, and image data representing only the Sales Department are selected, the CPU 11 may set all of the image data as the input data. Further, the input data need not include passwords and/or user IDs.

The second input field 612 is an area that receives a user prompt describing information on functional restrictions to be set for each group. The user prompt is in the form of written text through character input. A user prompt entered in the second input field 612 is data specifying the relationship between each group name included in the organizational structure information selected with the first input button 611, and the settings of functional restrictions assigned to the group specified by that group name. The input data received through the second input field 612 is an example of the second user input data. The second input field 612 is an example of the input screen for the prompt.

A user prompt entered into the second input field 612 is data specifying, for each user included in the organizational structure information that has been selected with the first input button 611, the relationship between that the user and settings of functional restrictions through the group to which the user belongs. When groups are configured by department name based on the organizational structure information shown in FIG. 7, for example, the user prompt entered into the second input field 612 may be a sentence as follows: “Please grant the General Affairs Department and Development Department authorization to perform only printing and the Sales Department authorization to perform only printing and scanning.” That is, the user prompt specifies the relationship between each group and the condition for the group for the functional restrictions. In other words, the combination of the user prompt and the organizational structure information enables the trained model to the relationship to each user belonging in each group and settings of the functional restrictions to that user. In other words, the user prompt specifies a condition for one or more settings for the one or more groups.

Since the MFP 1 can accept settings of functional restrictions for each group, the administrator can enter information indicating the settings for each group in the second input field 612 as a user prompt. Further, in a case where data specifying an organizational structure already exists, the administrator can specify this data by selecting the data with the first input button 611. Hence, this configuration can reduce the time and effort required to input user information, even when there are many users. Further, since the settings of functional restrictions can be specified in natural language for each group as a user prompt, even administrators unfamiliar with configuration operations for the MFP 1 can easily input the input data. In other words, the MFP 1 offers great flexibility in how data is selected through the first input button 611 and entered into the second input field 612, making the MFP 1 user-friendly.

The input data selected with the first input button 611 may have the same format as input data entered into the second input field 612. Thus, the CPU 11 may be able to receive prompt input rather than receiving a selection of image data through the first input button 611, for example. In this case, the data (file) in which the prompt is included may be selected through the first input button 611. Alternatively, the data entry screen 61 may include an input field instead of the first input button 611 to receive a prompt specifying the organizational structure input by the administrator. The CPU 11 may also be able to receive a selection of data (file) through the second input field 612, such as data (file) specifying the organizational structure and/or data (file) specifying settings of functional restrictions for groups. The administrator can easily prepare input data when the input data selected through the first input button 611 has the same format as input data entered into the second input field 612.

In S203 of FIG. 5, the CPU 11 determines whether an operation on the Execute button 615 has been received through the displayed data entry screen 61. When the CPU 11 determines that an operation on the Execute button 615 has not been received (S203: NO), in S204 the CPU 11 determines whether an operation on the Cancel button 616 has been received. When the CPU 11 determines that an operation on the Cancel button 616 has not been received (S204: NO), the CPU 11 waits until an operation on the Execute button 615 or Cancel button 616 is received.

When the CPU 11 determines that an operation on the Execute button 615 has been received (S203: YES), in S206 the CPU 11 determines whether the input data selected through the first input button 611 and the input data entered into the second input field 612 is appropriate data. When the CPU 11 determines that such input data is not appropriate (S206: NO), in S207 the CPU 11 displays an error message indicating that the input is not valid and returns to S201 to redisplay the data entry screen 61. The CPU 11 may also highlight the input items that are invalid. The CPU 11 determines that input data is not appropriate when no data has been selected in the first input button 611, the data selected in the first input button 611 is unreadable, or no data has been entered into the second input field 612, for example.

When the CPU 11 determines that the input data in both the first input button 611 and second input field 612 is appropriate (S206: YES), in S211 the CPU 11 obtains the specific prompt 26 and structural information 27. When the specific prompt 26 and structural information 27 are stored in the memory 12 (see FIG. 1), the CPU 11 acquires this information by reading the information from the memory 12. The specific prompt 26 is an example of the specific data.

The specific prompt 26 is data specifying instructions requesting that the settings of functional restrictions recommended for each user be outputted as output data in a format that the MFP 1 can interpret based on the two sets of input data received in the data entry screen 61. The specific prompt 26 includes an instruction to generate output data based on the input data and the structural information 27, an instruction to output the generated output data to the MFP 1, and an instruction to restrict the format of the output data to be generated based on the structural information 27. That is, the specific prompt instructs the trained model to return the output data satisfying a condition. This condition includes: a requirement that the output data includes one or more recommended setting datasets based on the two sets of input data, and includes a subject-setting relationship based on the two sets of first input data; and a requirement that the subject-setting relationship indicates that each of the one or more users corresponds to one of the one or more recommended setting datasets.

The structural information 27 is data indicating the format of information that can be interpreted by the MFP 1 and indicating the structure of information that can be used to set functional restrictions on the MFP 1. In a case where the MFP 1 has a configuration function for storing information in the above functional restriction information 23 and user information 24 based on settings data described in the JSON format, the structural information 27 may be information specifying JSON Schema. In this case, the JSON Schema includes parameter information specifying formats that can be inputted into the MFP 1. For example, the JSON Schema includes information specifying that group names in the group name field 511 of the entry field 51 (see FIG. 3) and usernames in the username field 521 of the entry field 52 (see FIG. 4) take character string input. That is, the JSON schema specifies data schema specifying structure of data. That is, the JSON schema specifies how a plurality of sets of data is organized and/or how the plurality of sets of data is associated. The JSON schema, in this example, specifies the items of the functional restrictions in the entry field 51 (FIG. 3) and items in the user list in the entry field 52 (FIG. 4). The JSON schema further specifies the relationship among the items. Specifically, the JSON schema specifies that first items including the group name item associated with items for availability of functions, such as printing function and copying function. The JSON schema also specifies second items of user associated with the group name. Since the first items and the second items both includes the group name item, the first items and the second items are associated through the group name. The JSON schema further specifies types of values assigned to each item.

In a case where the structural information 27 is information specifying JSON Schema, the specific prompt 26 is data specifying instructions requesting the output of output data containing information arranged in the JSON format, which is a format that the MFP 1 can interpret, where the output data specifies settings of functional restrictions recommended for each user in the organizational structure information selected through the first input button 611. This specific prompt 26 is based on the user prompts entered into the second input field 612.

The following is an example of the specific prompt 26 for this case. “Please output output data conforming to the JSON Schema format based on the input data in the two input fields. The output data should be JSON information only. The JSON information should describe the correlations between usernames and group names based on the input data. Each ‘username’ listed under ‘userlist’ in the JSON Schema corresponds to a username, while ‘groupname’ under ‘userlist’ corresponds to the group to which the user belongs. Based on the input data, availability information associated with the group name should be described under ‘restrictedfunction.’ The ‘groupname’ under ‘restrictedfunction’ in the JSON Schema corresponds to a group, while ‘print’ corresponds to printing, ‘copy’ to copying, ‘faxsend’ to fax transmissions, ‘faxrecv’ to fax receptions, . . . . Enter a 1 for print, copy, faxsend, faxrecv, . . . if the function is available and a 0 if unavailable.” The specific prompt 26 specifies conditions for the output data. The specific prompt 26 specifies that the data format is specified in the structural information 27, and specifies how the items related to the users and groups in the structural information 27 correspond to organizational structure information.

Note that the specific prompt 26 and structural information 27 may already be stored in the memory 12 when the MFP 1 is shipped from the factory, for example, or the MFP 1 may acquire or obtain the specific prompt 26 and structural information 27 from a server or other external device upon receiving an administrator operation on the settings support button 43 (see FIG. 3 or 4) in the settings menu displayed in S101 of the settings information reception process (see FIG. 2). The specific prompt 26 and structural information 27 may also differ by model.

In S212 the CPU 11 passes the two sets of input data received through the data entry screen 61 that has been displayed in S201 and the specific prompt 26 and structural information 27 acquired in S211 to the generative AI server 200 to be inputted into the trained model. The CPU 11 may pass all four sets of data to the generative AI server 200 at once or may pass portions of the data sequentially. The process of S212 is an example of an input process.

The generative AI server 200 may perform various processes on the data received from the MFP 1 to the extent that the meaning of the data is not significantly altered before inputting the data into the trained model. For example, the generative AI server 200 may perform processes known as filtering processes for enhancing features in or removing noise from the input data. In this specification, inputting processed data into the trained model falls within the concept of the MFP 1 inputting data into the trained model. Here, the processed data is data on which various processes have been performed on data sent from the MFP 1.

The trained model of the generative AI server 200 generates a response based on each inputted prompt and each inputted set of data and outputs the generated responses to the MFP 1. Therefore, in S213 the CPU 11 can receive responses generated by the trained model after inputting the data in S212. In other words, by passing four sets of data to the trained model, including the two sets of data inputted by the administrator and the two sets of data acquired by the MFP 1, the CPU 11 can expect to obtain output data in a usable form for the MFP 1.

As with the input data, the generative AI server 200 may perform various processes on data outputted from the trained model to the extent that the meaning of the data is not significantly altered before transmitting the data to the MFP 1. In this specification, the MFP 1 receiving data that has undergone various processes after being outputted from the trained model falls within the concept of the MFP 1 receiving data outputted from the trained model.

In S215 the CPU 11 determines whether the responses received from the generative AI server 200 conform to the structure specified by the structural information 27. In this determination of S215, the CPU 11 may determine whether the response specifies the first items including the group name item associated with items for availability of functions and the second items of user associated with the group name. Further, the CPU 11 may determine whether the first items and the second items are associated through the group name. When the CPU 11 determines that the responses conform to the specified structure (S215: YES), in S216 the CPU 11 sets the output data last outputted from the generative AI server 200 as provisional settings information.

The provisional settings information that conforms to the specified structure is data in the JSON format. The “userlist” in the provisional settings information describes correlations between usernames such as “User SA” and group names such as “General Affairs Department” based on the input data. For example, “User SA” through “User SC” are associated with “General Affairs Department” and “User KA” and “User KB” are associated with “Development Department.” Further, “User SA” and others specified in the data representing the organizational structure are described under “username” in the provisional settings information. “General Affairs Department” and others specified in the data representing the organizational structure are described under “groupname.”

Further, information specifying the availability of each functional item such as printing and copying is described under “restrictedfunction” in association with each group name, such as “General Affairs Department” based on the input data. Specifically, “1” is set for “print” if printing is allowed and “0” is set for “print” if printing is not allowed. With respect to the “General Affairs Department” and the “Development Department” in the input data described above, “1” representing available is set only for printing while “0” representing unavailable is set for copying and other functions.

When the CPU 11 determines in S215 that the received responses do not conform to the specified structure (S215: NO), the CPU 11 discards the responses obtained on this occasion. For example, the CPU 11 may determine that the responses do not conform when the MFP 1 cannot interpret the output data or when the obtained responses are not described in the JSON format, despite information specifying JSON Schema being inputted as the structural information 27.

When the CPU 11 determines in S215 that the responses do not conform, in S218 the CPU 11 determines whether the number of times that the CPU 11 transferred four sets of data to the generative AI server 200 in S212 to request a response has exceeded a predetermined number. When the CPU 11 determines that the number of requests has not exceeded the predetermined number (S218: NO), the CPU 11 returns to S212 and passes the same four sets of data as before to the generative AI server 200 again. Because there is a possibility that the trained model of the generative AI server 200 will output different responses based on the same input data, responses different from before can be expected. The predetermined number in this case may be 3, for example.

When the CPU 11 determines that responses conforming to the specified structure could not be obtained, even after inputting data more than the predetermined number of times (S218: YES), in S219 the CPU 11 displays an error screen indicating that appropriate responses could not be obtained. For example, the CPU 11 may display a message prompting the user to modify and re-input the input data.

Following the process of S216 or S219 or when the CPU 11 determines in S204 that an operation on the Cancel button 616 has been received through the data entry screen 61 displayed in S201 (see FIG. 6; S204: YES), the CPU 11 ends the settings support process and returns to the settings information reception process in FIG. 2.

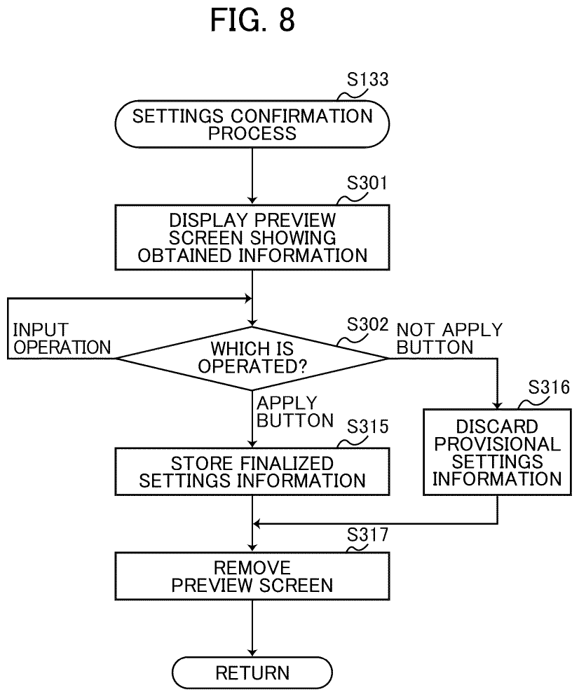

Returning to the description of the settings information reception process in FIG. 2, after completing the settings support process of S131, in S132 the CPU 11 determines whether the provisional settings information has been acquired. When the CPU 11 determines that data outputted from the generative AI server 200 has been acquired as the provisional settings information in S216 of the settings support process (S132: YES), in S133 the CPU 11 executes a settings confirmation process. Steps in the settings confirmation process will be described next with reference to the flowchart in FIG. 8. When the CPU 11 determines that data outputted from the generative AI server 200 has not been acquired (S132: NO), the CPU 11 returns to the process of S101.

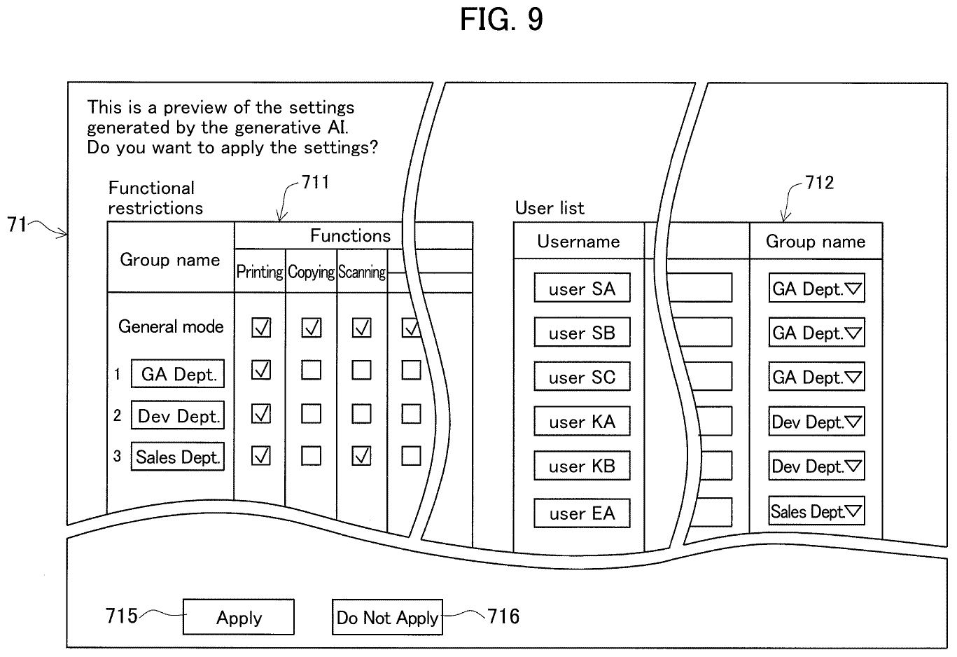

In S301 of the settings confirmation process, the CPU 11 displays a preview screen 71 on the user interface 13 showing the functional restriction information 23 and user information 24 with the provisional settings information obtained in S216 of the settings support process set as functional restriction information for the MFP 1. FIG. 9 shows an example of the preview screen 71 that the CPU 11 displays on the user interface 13 based on the provisional settings information. As shown in FIG. 9, the preview screen 71 includes a provisional functional restriction field 711, a provisional user list field 712, an Apply button 715, and a Do Not Apply button 716. The provisional functional restriction field 711 in FIG. 9 shows an example in which the provisional settings information has been applied to the entry field 51 described above (see FIG. 3). Similarly, the provisional user list field 712 in FIG. 9 shows the provisional settings information applied to the entry field 52 described above (see FIG. 4). The process of S301 is an example of the displaying process.

In S302 the CPU 11 receives operations from the administrator in the preview screen 71 displayed in S301. Specifically, the CPU 11 can receive operations specifying instructions to modify the provisional functional restriction field 711 and provisional user list field 712 in the display, as well as an operation on the Apply button 715 and the Do Not Apply button 716. Although only partially displayed in FIG. 9, input fields for the password, user ID, and the like may also be included in the provisional user list field 712 of the preview screen 71, as in the entry field 52 for the user list shown in FIG. 4. In this case, the administrator can input passwords and user IDs into the preview screen 71.

The CPU 11 can copy the provisional settings information acquired in S216 of the settings support process into RAM (the memory 12) and can modify this copied information in response to operations inputted by the administrator. When the CPU 11 receives an operation in one of the provisional functional restriction field 711 and provisional user list field 712 of the preview screen 71 (S302: input operation), the CPU 11 reflects this operation in the preview screen 71 and continues to receive instructions.

When the CPU 11 receives an operation on the Apply button 715 (S302: apply), in S315 the CPU 11 stores the provisional settings information in the memory 12 as finalized settings information. Note that when the provisional settings information has not been modified through input operations by the administrator, in S315 the CPU 11 stores the provisional settings information acquired in S216 of the settings support process in the memory 12 unaltered. In this case, the provisional settings information becomes the finalized settings information. Thus, the Apply button 715 may be considered a button that receives a selection to store, in the memory 12, the settings displayed based on information represented by the data outputted from the trained model. The process of S315 is an example of the setting process. The process of S302 to receive the operation on the Apply button 715 is an example of the preview process.

When the provisional settings information has been modified through input operations of the administrator, on the other hand, in S315 the CPU 11 stores the modified information as the settings information. The MFP 1 can accept correction instructions in the preview screen 71 to correct responses received from the trained model. Therefore, even when errors are present in some of the provisional settings information obtained from the trained model, the administrator can obtain appropriate settings information simply by performing operations to correct those errors, without having to query the trained model again. As shown in FIG. 9, the preview screen 71 is an input screen for the administrator to perform the manual input described above, i.e., a screen having a similar configuration to the entry field 51 for receiving functional restriction information 23 (see FIG. 3) and the entry field 52 for receiving user information 24 (see FIG. 4). Thus, the administrator can easily confirm or correct output data that has been outputted from the trained model.

When the CPU 11 receives an operation on the Do Not Apply button 716, on the other hand (S302: do not apply), in S316 the CPU 11 discards the provisional settings information. In this case, the CPU 11 does not store the settings information in the memory 12.

As described above, the MFP 1 does not immediately finalize the settings information outputted from the trained model, but rather displays this settings information in the preview screen 71 as provisional settings information and receives a selection by the administrator as to whether to confirm the settings information based on this content, i.e., whether to store the settings information in the memory 12. In other words, the MFP 1 determines whether or not to store the settings information obtained from the trained model in the memory 12 in accordance with the selection received in the preview screen 71. This reduces the chance of erroneous settings information being stored as is when such errors are present in the settings information obtained from the trained model.

While the MFP 1 can accept manual settings for functional restrictions through the entry field 51 (see FIG. 3) and the entry field 52 (see FIG. 4), the administrator may input organizational structure information and user prompts into the first input button 611 and second input field 612 instead of performing the above input operations, and the MFP 1 can obtain provisional settings information to be stored in the memory 12. Hence, instead of inputting the usernames of many users, the administrator need only prepare data showing the structure of the organization, thereby avoiding the time and effort required for performing the input operations.

Following step S315 or S316, in S317 the CPU 11 4 71 from the display, ends the settings confirmation process, and returns to the settings information reception process.

Even in a case where the data outputted from the generative AI server 200 is in an appropriate format and the CPU 11 reaches a YES determination in S215 of the settings support process (see FIG. 5), the structure of the information may still not conform to the required structure when attempting to set the functional restriction information 23 and user information 24 based on that output data. In such cases, the CPU 11 may discard the provisional settings information so that the settings information is not stored in the memory 12 based on the provisional settings information. In this case, the CPU 11 may an error report or may re-execute the settings support process. Further, when the CPU 11 determines that the preview screen cannot be displayed appropriately in S301, the CPU 11 may issue an error report or may re-execute the settings support process.

Returning to the settings information reception process of FIG. 2, following any of steps S115, S125, and S133, in S141 the CPU 11 determines whether an instruction to quit settings has been received. When the CPU 11 determines that an instruction to quit settings has not been received (S141: NO), the CPU 11 returns to S101 and re-displays the settings menu. The CPU 11 may advance to steps S141 after determining in S132 that appropriate output data could not be obtained from the generative AI server 200 in the settings support process (S132: NO).

The settings menu may include a plurality of options other than those shown in FIGS. 3 and 4, and the CPU 11 can also accept an instruction to quit settings while the settings menu is displayed. Once the CPU 11 determines that an instruction to quit settings has been received (S141: YES), the CPU 11 ends the settings information reception process.

As described above in detail, the MFP 1 according to the first embodiment receives organizational structure information and a user prompt through interfaces such as the EWS 22 and the user interface 13. The organizational structure information specifies the relationships among individual users and the groups to which the users belong (i.e., the subjects of the settings). The user prompt specifies functional restriction settings by group. The MFP 1 then inputs this received data into the trained model together with the specific prompt 26 and structural information 27 that have been prepared in advance. The specific prompt 26 and structural information 27 provide instructions to the trained model to output recommended settings for each user in a format that the MFP 1 can interpret. The MFP 1 can then store information indicating the settings for each user in the memory 12 based on the output data from the trained model. This process eliminates the need to input information for each individual user and reduces the time and effort required for the administrator to input such settings, even when settings are being stored for many users.

Next, an electronic device according to a second embodiment will be described in detail while referring to the accompanying drawings. The second embodiment differs from the first embodiment only in the structural information and specific prompts to be inputted into the trained model, while the steps in all processes are identical to those in the first embodiment. In the following description, components and process steps identical to those in the first embodiment will be designated with the same reference numerals and step numbers to avoid duplicating description.

The MFP 1 according to the second embodiment uses HTML data instead of the JSON Schema as the structural information 27. Depending on the model, for example, the MFP 1 may not be provided with a JSON Schema file specifying the structure of information that can be used to set functional restrictions. However, as long as the MFP 1 is provided with the EWS 22, for example, the MFP 1 has HTML data for displaying the entry field 51 (see FIG. 3) that receives input for the functional restriction information 23 and the entry field 52 (see FIG. 4) that receives input for the user information 24 in the browser 31. The MFP 1 according to the second embodiment passes this HTML data to the generative AI server 200 as structural information 27. The entry fields 51 and 52 are examples of the menu screen. The HTML data is an example of the screen data.

Similarly to the JSON schema (JSON information) in the first embodiment, the combination of the HTML data for displaying the entry field 51 (see FIG. 3) and the HTML data for displaying the entry field 52 specifies organization of data for items and the relationship therebetween.

When HTML data is used as structural information 27, the specific prompts are expressed differently than when using the JSON Schema. The specific prompt 26 in the second embodiment is data that includes instructions to determine setting items from the HTML data and to output recommended settings based on the input data in a data format that the MFP 1 can interpret.

The trained model in this embodiment can interpret HTML data. For example, the trained model can identify what part of the HTML data indicates whether a given checkbox is checked or unchecked. Based on the two sets of input data entered by the administrator, the trained model can then acquire the information that would be POSTed when this HTML data is modified to include the recommended settings. That is, the two sets of input data enable the trained model to acquire information on setting values to be included in the output data.

The following is an example of the specific prompt 26 when HTML data is used as structural information. “Please execute the following process in order of Steps 1 through 3 in accordance with the constraints and output the response. ###Constraints: Output in JSON format the values that would be POSTed when the HTML data is modified, and the modified HTML data is sent. ###Execution steps: Step 1. Identify each item included in the functional restrictions input field and the user list input field based on the inputted HTML data. Step 2. Identify the recommended setting for each item identified in Step 1 based on the organizational structure information and the user prompt and format the settings appropriately for each item. Step 3. Output in JSON format the values that would be POSTed when the information formatted in Step 2 is entered into each HTML data item in the browser.”

Even when using the structural information 27, which is HTML data, and the specific prompt 26 described above, the CPU 11 displays the settings menu (see FIG. 3; S101 of FIG. 2), as in the first embodiment, and receives input from the administrator (S102). When an operation on the settings support button 43 is received (S102: settings support), the CPU 11 executes the settings support process (see FIG. 5; S131), as described in the first embodiment. In S203 of the settings support process, the administrator may input data similar to that in the organizational structure information and user prompt described above into the data entry screen 61 (see FIG. 6), as described in the first embodiment.

In the present embodiment, the CPU 11 acquires the structural information 27, which is HTML data, and the specific prompt 26 described above in S211 of the settings support process. In S212 the CPU 11 then passes the input data that the administrator entered in the two fields to the generative AI server 200 together with the specific prompt 26 and structural information 27.

HTML data possessed by the EWS 22 is also information specifying the setting items for which the MFP 1 can accept settings. In other words, the MFP 1 acquires this HTML data and the specific prompt 26 and passes these set of data to the trained model together with the data inputted by the administrator to obtain output data in the JSON format specifying information that can be set on the MFP 1.

The content of settings specified by output data in the JSON format, which the trained model outputs to the MFP 1 in this embodiment, is essentially the same as settings content in the first embodiment. For example, the output data in JSON format includes a description for associating usernames such as “User SA” with group names such as “General Affairs Department” based on input data from the MFP 1. Further, the output data in JSON format includes information indicating the availability of printing, copying, and other functions in association with group names such as “General Affairs Department” based on the input data from the MFP 1.

After completing the settings support process of S131, the CPU 11 may return to S101 without proceeding to S132 and redisplays the settings menu. When the functional restrictions button 41 (FIG. 3) is operated in the settings menu, the CPU 11 displays an input field having the same structure as the entry field 51 shown in FIG. 3 and that contains information on group names and the like based on the acquired output data. Further, when the user list button 42 is operated in the settings menu, the CPU 11 displays an input field having the same structure as the entry field 52 shown in FIG. 4 and that contains information such as usernames based on the acquired output data.

The CPU 11 can accept operations for additional input and corrections in each displayed input field, just as in the case of manual input. Further, when an operation on the OK button 515 or 525 (FIGS. 3-4) is received, the CPU 11 stores the information displayed in the corresponding input field in the memory 12 as settings information. In this case, the process of displaying an input field having the same structure as the entry field 51 in FIG. 3 and the process of displaying an input field having the same structure as the entry field 52 in FIG. 4 are examples of the preview process.

In a case where the MFP 1 is capable of interpreting HTML data to acquire settings information from that HTML data, a specific prompt may be used with an instruction requesting that HTML data be outputted as the output data. In this case, Step 3 in the specific prompt 26 may state “Output HTML data in a state where the information formatted in Step 2 is entered into each item in the HTML data if such information is inputted in the browser.” That is, Step 3 in the specific prompt 26 may state “Output HTML data with the information formatted in Step 2 entered into each item in the HTML data.”

As described above in detail, a configuration function using a trained model can be implemented easily with the MFP 1 according to the second embodiment. By using HTML data as the structural information 27, the MFP 1 according to the second embodiment can use a specific prompt common to each model. With the MFP 1 according to the second embodiment, as in the first embodiment described above, information need not be inputted for each individual user, reducing the time and effort required by the administrator to perform operations to input settings, even when settings are to be stored for many users.

On the other hand, structural information 27 specifying the JSON Schema is used for various settings on the MFP 1, including functional restriction settings, and includes information indicating which setting values for items are configurable. The MFP 1 according to the first embodiment is likely to obtain output data in the JSON format with information specifying settings configurable on the MFP 1 itself.

Next, an electronic device according to a third embodiment of the present disclosure will be described while referring to the accompanying drawings. The MFP 1 according to the third embodiment differs from the MFP 1 in the first and second embodiments in that, rather than inputting the structural information 27 into a trained model, the MFP 1 requests the trained model to call functions supported by the MFP 1 and returns information equivalent to the structural information 27 to the trained model in response. The settings support process in the third embodiment is the only process that differs from that in the first embodiment. Components and process steps similar to those in the first embodiment are designated with the same reference numerals and step numbers to avoid duplicating description.

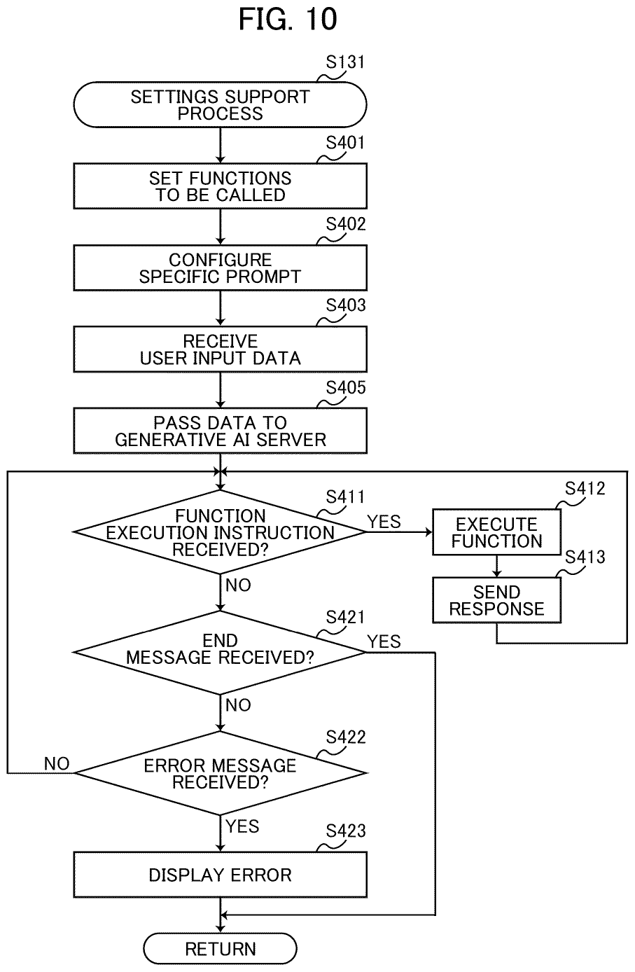

As with the MFP 1 according to the first embodiment, when the MFP 1 according to the third embodiment receives an instruction to begin configuring settings, in S101 of the settings information reception process the MFP 1 displays the settings menu (see FIG. 3). When the CPU 11 determines that an operation on the settings support button 43 has been received in the displayed settings menu (S102: settings support), in S131 the CPU 11 executes the settings support process. Steps in the settings support process according to the third embodiment will be described with reference to the flowchart in FIG. 10.

In the third embodiment, the MFP 1 directs the trained model to call functions. To do this, in S401 the CPU 11 sets (determines) functions to be called. In this example, the MFP 1 sets an item acquisition function and a preview setting function as the functions to be called. The item acquisition function is called with the model name of the MFP 1 as an argument and returns information on a list of items for which values can be configured for that model. The preview setting function is called with values to be set for setting items as arguments in order to display a preview of the settings results and to accept instructions for modifying and applying the settings. The preview setting function returns information indicating whether the preview has been successfully executed.

The MFP 1 registers or sets, in the trained model, information including the names and details of these functions, information on types of arguments to be passed, and information specifying or limiting the arguments via the application programming interface (API) of the generative AI server 200, enabling the trained model to call these functions. The MFP 1 may store information on these functions to be registered or set in the trained model via the API in the memory 12 in advance or may acquire (or obtain) the information from a server or the like.

This concept of registering (or setting) information in the trained model will be referred to as registering function information in the trained model for convenience, but the concept involves registering function information on the generative AI server 200 provided with the trained model. The following description will also refer to the trained model calling functions of the MFP 1 for convenience, but this concept involves the generative AI server 200 provided with the trained model calling functions of the MFP 1 as part of processes related to the trained model.

In S402 the CPU 11 further configures a specific prompt describing a procedure using function calls. The specific prompt in this case is a different expression from the specific prompt used with the structural information 27. Specifically, the specific prompt in the third embodiment is data specifying instructions to call functions provided by the MFP 1 and to use the responses for outputting recommended settings based on the input data in a configurable format for the MFP 1.

The following is an example of a specific prompt for using function calls. “Please execute the following process in order of Steps 1 through 6 in accordance with the constraints and output the response. ###Constraints: Respond with an end message when all steps are completed. Otherwise, perform function calls or respond with an error message in the case of an abnormality. ###Execution steps: Step 1. Call the item acquisition function of the target device and acquire information for a list of items for which values are configurable. Step 2. Identify items for the functional restriction information and user list based on the information for the list for which values are configurable. Step 3. Identify the recommended settings for the target items for which values are configurable based on the organizational structure information and the user prompt. Step 4. Reformat the settings determined in Step 3 to be appropriate as arguments for the preview setting function. Step 5. Call the preview setting function of the target device using the settings formatted in Step 4 as arguments. Step 6. Return the results of Step 5.”

In S403 the CPU 11 receives input of user input data. As in the first embodiment, user input data is organizational structure information and a user prompt, for example. Note that the order of S401-S402 and S403 may be arbitrary. For example, the order of S401-S403 may be reversed. Further, the MFP 1 may store a specific prompt for the functions in the memory 12 in advance or may acquire the specific prompt from a server or the like.

In S405 the CPU 11 passes the specific prompt for functions set in S402 and the two sets of input data received in S403 to the generative AI server 200 to be inputted into the trained model. This embodiment does not require the structural information 27 to be passed to the generative AI server 200. The trained model is capable of executing a process with specified steps based on the inputted specific prompt for functions.

In S411 the CPU 11 determines whether an instruction to execute a function has been received from the trained model. For example, the trained model calls the item acquisition function of the MFP 1 in Step 1. When the CPU 11 determines that the trained model called the item acquisition function (S411: YES), in S412 the CPU 11 executes this item acquisition function and in S413 returns information on the list of items for which values are configurable to the trained model as the result. Specifically, the MFP 1 passes information to the trained model indicating a list of setting items for which values are configurable on the MFP 1. The MFP 1 has a transmission function for sending information on the list of items for which values are configurable to the source that requested the information by calling the item acquisition function. The process of S411 executed in response to the invocation of the item acquisition function is an example of the requesting the structural information (the information indicating the data structure). The list of setting items for which values are configurable is an example of the structural information (the information indicating the data structure).

The information on the list of items for which values are configurable is information that the MFP 1 returns, and includes specifically information indicating which functions of the MFP 1 can be set to available or unavailable. The MFP 1 passes information to the trained model indicating which of the print, copy, scan, and other functions can be set as available or unavailable. The MFP 1 need not pass information to the trained model indicating functions without an availability setting. For example, in a case where the MFP does not have facsimile communication functions, the list information passed to the trained model need not include the fax transmission and fax reception items.

When the CPU 11 determines in S411 that a function has not been called (S411: NO), in S421 the CPU 11 determines whether an end message has been received. When the CPU 11 determines that an end message has not been received (S421: NO), in S422 the CPU 11 determines whether an error message has been received. When the CPU 11 determines that an error message has not been received (S422: NO), the CPU 11 waits until an instruction to execute a function (S411), an end message (S421), or an error message (S422) has been received.

After acquiring information on the list of items for which values are configurable in Step 1, the trained model executes Steps 2-4 in sequence. When an abnormality occurs during the process from Step 2 to Step 4, the trained model outputs an error message based on the restriction condition.

When the process in Steps 2 through 4 is successful, the trained model calls the preview setting function in Step 5. When the CPU 11 determines in S411 that the preview setting function has been called by the trained model (S411: YES), in S412 the CPU 11 executes this preview setting function. By executing the preview setting function, the CPU 11 can obtain the arguments set by the trained model, and display a proper preview provided that the arguments passed from the trained model when calling the preview setting function are in an appropriate format. In this case, a preview screen shown in FIG. 9 may be displayed. When the preview display is successful, in S413 the CPU 11 returns information to the trained model indicating that the preview display has been successful. Settings passed to the MFP 1 as arguments for the preview setting function are an example of the output data.

When the data inputted by the administrator is the same as the data in the first embodiment, the settings content specifying settings that the trained model passed to the MFP 1 as arguments for the preview setting function is essentially the same content as that in the first embodiment. For example, the settings include settings content associating usernames such as “User SA” with group names such as “General Affairs Department” based on the input data received from the MFP 1. The settings may also include settings content indicating the availability of printing, copying, and other functions associated with the group names, such as “General Affairs Department,” based on the input data received from the MFP 1.

In this embodiment, the trained model passes settings indicating availability to the MFP 1 as arguments for the preview setting function only for those functions specified in the list of configurable items received from the MFP 1. For example, when the MFP is not provided with facsimile communication functions, the MFP 1 passes list information on items that does not include the fax transmission and fax reception items to the trained model. As a result, settings returned by the trained model to the MFP as arguments for the preview setting function do not contain any information on the availability of fax transmission and fax reception.

When in S413 the CPU 11 returns the information to the trained model indicating that the preview display has been successful, the trained model returns an end message in Step 6 as a response based on the information acquired in S413. In response to receiving an end message from the trained model (S421: YES), the CPU 11 ends the settings support process. In this case, the arguments passed from the trained model when the model calls the preview setting function are an example of the output data. When the display has been successful, the CPU 11 may store those settings in the memory 12.

In a case where the arguments passed by the trained model when calling the preview setting function are not in an appropriate format, on the other hand, the CPU 11 fails to display the preview. Even when the preview display has been successful, the CPU 11 may also accept an instruction in the displayed preview screen not to apply the settings. When the display fails or an instruction not to apply the settings is received, in S413 the CPU 11 returns information indicating a failure to the trained model.

When the response indicates a failure, the trained model returns an error message in Step 6. When an error message is received from the trained model (S422: YES), in S423 the CPU 11 displays the error and ends the settings support process. In this case, the CPU 11 discards the arguments passed from the trained model when calling the preview setting function. Rather than ending the settings support process in this case, the CPU 11 may return to S405 and retransfer all the data to the generative AI server 200.

The specific prompt for functions need not include Step 6 in the execution procedure described above. The CPU 11 may execute the settings confirmation process (see FIG. 8) when the preview setting function called in Step 5 has been successfully executed. The CPU 11 may display an error message when execution of the preview setting function has failed.

As described above, the MFP 1 according to the third embodiment can also eliminate the need to input information for each individual user when performing settings related to functional restrictions and can reduce the time and effort required for the administrator to input such settings, even when settings are being stored for many users. The use of functions in this embodiment eliminates the need to prepare the structural information 27 in advance and the need to prepare specific prompts that differ by model.

The MFP 1 according to the first embodiment or second embodiment, on the other hand, must prepare the specific prompt 26 and structural information 27. However, processing is simplified since the MFP 1 need only interact with the trained model once to input data.

The electronic device of this invention is not limited to a device possessing image formation functions but may be any device having a communication interface for communicating with the generative AI server 200 and memory capable of storing various settings. In other words, the electronic device is not limited to the MFP 1 but may be a printer (having only a printing function), a copier, a scanner, a fax machine, an embroidery machine, a machine tool (cutting machine, polishing machine, or laser processing machine), or a liquid ejection device (inkjet device, etc.). Further, configurable items and their settings may differ according to the functions possessed by the electronic device. For example, the settings are not limited to information indicating the availability of functions but may also be information indicating the range of values that can be set when using each function.

The display format indicated in the above embodiments is not limited to the examples in the drawings. For example, while the preview screen 71 shown in the example of FIG. 9 displays the provisional functional restriction field 711 and the provisional user list field 712 side by side on the left and right, respectively, the CPU 11 may juxtapose the provisional functional restriction field 711 and provisional user list field 712 vertically. Further, the CPU 11 may display a preview screen including one of the provisional functional restriction field 711 and provisional user list field 712 and a toggle button and may toggle the display between the provisional functional restriction field 711 and provisional user list field 712 in response to receiving an operation on the toggle button.

The above embodiments provided an example of identifying each user that uses the MFP 1 by a username, but users may be identified by user IDs instead. For example, “userlist” in the JSON information may be configured to associate “userid” corresponding to a user ID instead of “username” corresponding to a username with “groupname.” In this case, the administrator should input organizational structure information containing user IDs as the input data. Further, the organizational structure information need not include usernames. User IDs may also be displayed in place of usernames in the preview screen 71 of the first embodiment (see FIG. 9), the entry field 51 or entry field 52 based on output data in the second embodiment, and the preview display displayed by the preview setting function in the third embodiment, and the displays may receive the input of usernames.

The settings confirmation process (see FIG. 8) may be omitted. In this case, when the CPU 11 acquires a response from the trained model that conforms to the structure specified in the settings support process (see FIG. 5), the CPU 11 may store settings in the memory 12 based on this response. However, displaying a preview of the settings before the settings are stored can eliminate the possibility of using settings that differ significantly from the administrator's intentions.

In the settings confirmation process of the above embodiments, the MFP 1 not only accepts a selection in the preview display indicating whether to apply the settings but also accepts instructions for correcting the settings (S302 of FIG. 8), but the MFP 1 need not accept instructions for correcting settings. That is, when the settings contain an error, the MFP 1 may simply redo the process from the beginning without storing the provisional settings information in the memory 12.

In the settings support process of the above embodiments, the MFP 1 repeatedly inputs the same data into the trained model up to a predetermined number of times (i.e., returns to S212 of FIG. 5 while reaching a NO determination in S218). However, instead of repeatedly inputting the data, the CPU 11 may end the process and reenter a state for accepting instructions.

While the above embodiments give an example of dividing a plurality of users into a plurality of groups and accepting functional restriction settings for each group, the MFP 1 is not limited to accepting settings by group but may also accept settings for individual users. For example, the MFP 1 may be capable of displaying an entry field combining the entry field 51 shown in FIG. 3 with the entry field 52 shown in FIG. 4. The MFP 1 may also display a preview screen that associates provisional settings information with each user in place of the preview screen 71 shown in FIG. 9.

The above embodiments illustrate a configuration that uses the trained model of the generative AI server 200. However, in place of the trained model, the invention may be applied to a program created based on the coding of engineers (programmers) describing determination steps and other processes.

In any of the flowcharts disclosed in the embodiments, the plurality of processes that make up any of a plurality of steps may be executed in parallel, or the order in which the processes are performed may be modified in any way that does not produce any inconsistencies in the processes.

The processes disclosed in the embodiments may be executed by a single CPU, a plurality of CPUs, an application specific integrated circuit (ASIC) or other hardware, or a combination of these components. Further, the processes disclosed in the embodiments may be achieved through a storage medium that stores the programs used to implement those processes or according to any of various other methods or formats.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. An electronic device comprising:
a user interface;
a communication interface;
a memory; and
a controller,
wherein the controller is configured to perform:
receiving first input data and second input data through the user interface, the first input data being in a first format interpretable by a trained machine learning model running on a server, the first input data specifying an element relationship among a plurality of elements, the plurality of elements including one or more first subjects and one or more second subjects, the second input data being in a second format interpretable by the trained machine learning model, the second input data specifying a first condition for one or more settings for the one or more first subjects;
inputting, to the trained machine learning model through the communication interface, the first input data, the second input data, and specific data, wherein the specific data is data instructing the trained machine learning model to return output data satisfying a second condition, the second condition including: a requirement that the output data is in a third format interpretable by the controller; a requirement that the output data includes one or more recommended setting datasets based on both the first input data and the second input data, and includes a subject-setting relationship based on both the first input data and the second input data; and a requirement that the subject-setting relationship indicates that each of the one or more second subjects corresponds to one of the one or more recommended setting datasets;
storing, when the output data is received in response to performing the inputting, the one or more recommended setting datasets in the memory as one or more setting datasets so that each of the one or more second subjects is associated with a corresponding one of the one or more recommended setting datasets based on the subject-setting relationship included in the output data; and
processing for each of the one or more second subjects in accordance with a corresponding setting dataset associated with the each of the one or more second subjects among the one or more setting datasets stored in the memory.

2. The electronic device according to claim 1, further comprising:
an image formation engine,
wherein the processing for the each of the one or more second subjects includes controlling the image formation engine to form an image in accordance with the corresponding setting dataset.

3. The electronic device according to claim 2,
wherein the image formation engine has at least one of a printing function and a scanning function,
wherein the one or more first subjects are one or more groups, the one or more second subjects are one or more users, and the element relationship in the first input data includes information indicating which of the one or more groups each of the one or more users belongs to,
wherein the first condition specifies a required setting dataset for each of the one or more groups, the required setting dataset indicating whether each of a plurality of image formation functions is enabled or disabled, the plurality of image formation functions including the at least one of the printing function and the scanning function,
wherein the second condition further includes: a requirement that each of the one or more recommended setting datasets indicates whether each of the plurality of image formation functions is enabled or disabled; and a requirement that the subject-setting relationship includes information indicating that each of the one or more users is associated with one of the one or more recommended setting datasets,
wherein in the storing, the one or more recommended setting datasets are stored in the memory as the one or more setting datasets so that each of the one or more users is associated with the corresponding one of the one or more recommended setting datasets,
wherein when one of the one or more setting datasets indicates that one of the plurality of image formation functions is disabled, the controller performs the processing for one of the one or more users associated with the one of the one or more setting datasets with the one of the plurality of image formation functions disabled,
wherein when one of the one or more setting datasets indicates that one of the plurality of image formation functions is enabled, the controller performs the processing for one of the one or more users associated with the one of the one or more setting datasets with the one of the plurality of image formation functions enabled.

4. The electronic device according to claim 3,
wherein the controller is configured to further perform:
displaying on the user interface, when the output data is received from the trained machine learning model in response to performing the inputting, a preview screen including the one or more recommended setting datasets in such a manner that: the preview screen shows that each of the one or more users is associated with the corresponding one of the one or more recommended setting datasets; and a selection of whether to store the one or more recommended setting datasets in the memory can be received through the preview screen,
wherein the storing is performed only when a selection to store the one or more recommended setting datasets in the memory has been received through the preview screen.

5. The electronic device according to claim 3,
wherein the controller is configured to further perform:
displaying on the user interface, when the output data is received from the trained machine learning model in response to performing the inputting, a preview screen including the one or more recommended setting datasets in such a manner that: the preview screen shows that each of the one or more users is associated with the corresponding one of the one or more recommended setting datasets; a modification to modify any of the one or more recommended setting datasets can be received through the preview screen; and a selection of whether to store the one or more recommended setting datasets in the memory can be received through the preview screen,
wherein the storing is performed only when a selection to store the one or more recommended setting datasets in the memory has been received through the preview screen,
wherein in the storing, when a modification to modify one of the one or more recommended setting datasets is received through the preview screen, the controller stores the one of the one or more recommended setting datasets after the modification is made, instead of storing the one of the one or more of recommended datasets before the modification is made.

6. The electronic device according to claim 2,
wherein the controller is configured to further perform:
displaying, on the user interface, a screen including a first input field to receive a designated subject and a second input field to receive a designated setting dataset associated with the designated subject; and
storing as one of the one or more setting datasets, in the memory, the designated setting dataset so that the designated subject is associated with the designated setting dataset,
wherein the controller performs both the inputting and the storing the one or more recommended setting datasets even when neither the designated subject nor the designated setting dataset is received.

7. The electronic device according to claim 2,
wherein each of the one or more recommended setting datasets includes a plurality of recommended setting values, each of the plurality of recommended setting values being for a corresponding one of a plurality of parameters,
wherein the first condition includes a requirement for a value for each of the plurality of parameters,
wherein the storing includes assigning each of the plurality of recommended setting values to the corresponding one of the plurality of parameters,
wherein the controller is configured to further perform:
displaying, on the user interface, a screen including a first input field to receive a designated subject and a second input field to receive a plurality of designated setting values for the designated subject, each of the plurality of designated setting values corresponding to a respective one of the plurality of parameters; and
storing as one of the one or more setting datasets, in the memory, the plurality of designated setting values so that each of the plurality of designated setting values is assigned to the respective one of the plurality of parameters and the designated subject is associated with the plurality of designated setting values,
wherein the controller performs both the inputting and the storing the one or more recommended setting datasets even when the designated subject is not received and none of the plurality of designated setting values is received.

8. The electronic device according to claim 7,
wherein the controller is configured to further perform:
displaying on the user interface, when the output data is received from the trained machine learning model in response to performing the inputting, a preview screen including the one or more recommended setting datasets each of which includes the plurality of recommended setting values in such a manner that the preview screen shows that each of the one or more second subjects is associated with the corresponding one of the one or more recommended setting datasets.

9. The electronic device according to claim 2,
wherein the image formation engine has at least one of a printing function and a scanning function,
wherein the one or more first subjects are one or more groups, the one or more second subjects are one or more users, and the element relationship in the first input data includes information indicating which of the one or more groups each of the one or more users belongs to,
wherein the first condition specifies a required setting dataset for each of the one or more groups, the required setting dataset indicating whether each of a plurality of image formation functions is enabled or disabled, the plurality of image formation functions including the at least one of the printing function and the scanning function,
wherein the second condition further includes: a requirement that each of the one or more recommended setting datasets indicates whether each of the plurality of image formation functions is enabled or disabled; and a requirement that the subject-setting relationship includes information indicating that each of the one or more users is associated with one of the one or more recommended setting datasets,
wherein in the storing, the one or more recommended setting datasets are stored in the memory as the one or more setting datasets so that each of the one or more users is associated with the corresponding one of the one or more recommended setting datasets,
wherein when one of the one or more setting datasets indicates that one of the plurality of image formation functions is disabled, the controller performs the processing for one of the one or more users associated with the one of the one or more setting datasets with the one of the plurality of image formation functions disabled,
wherein when one of the one or more setting datasets indicates that one of the plurality of image formation functions is enabled, the controller performs the processing for one of the one or more users associated with the one of the one or more setting datasets with the one of the plurality of image formation functions enabled,
wherein the controller is configured to further perform:
displaying, on the user interface, a screen including a first input field to receive a designated subject and a second input field to receive a designated setting dataset associated with the designated subject; and
storing as one of the one or more setting datasets, in the memory, the designated setting dataset so that the designated subject is associated with the designated setting dataset,
wherein the controller performs both the inputting and the storing the one or more recommended setting datasets even when neither the designated subject nor the designated setting dataset is received.

10. The electronic device according to claim 1,
wherein the controller is configured to further perform:
displaying, on the user interface, a prompt receiving screen to receive a user prompt,
wherein the first input data includes the user prompt received through the prompt receiving screen,
wherein the specific data includes a specific prompt instructing the trained machine learning model to return the output data satisfying the second condition,
wherein the inputting inputs, to the trained machine learning model, the first input data including the user prompt, the second input data, and the specific data including the specific prompt.

11. The electronic device according to claim 10,
wherein the specific data including the specific prompt is stored in the memory before performing the displaying the prompt receiving screen.

12. The electronic device according to claim 1,
wherein the second condition further includes a requirement that the output data has a specific data structure conforming to a setting function,
wherein the controller is configured to further perform:
receiving, from the trained machine learning model, the output data using the setting function.

13. The electronic device according to claim 1,
wherein the second condition further includes a requirement that the trained machine learning model returns the output data by performing in order:
transmitting, to the controller, a request for structure information indicating a data structure for the output data;
generating the output data conforming to the data structure; and
outputting the generated output data,
wherein the controller is configured to further perform:
transmitting, in response to receiving the request for the structure information from the trained machine learning model, the structure information to the trained machine learning model using a transmitting function,
wherein the storing is performed when the output data is received subsequently to performing the transmitting the structure information,
wherein in the storing, the one or more recommended setting datasets included in the generated output data is stored in the memory.

14. The electronic device according to claim 1,
wherein the inputting further includes inputting, to the trained machine learning model, screen data representing a list screen including a list of the one or more setting datasets stored in the memory, the controller being configured to display the list screen based on the screen data,
wherein the second condition further includes a requirement that the one or more recommended setting datasets are based on the first input data, the second input data, and the screen data.

15. The electronic device according to claim 1,
wherein the specific data is stored in the memory in advance,
wherein in the inputting, the specific data read from the memory is inputted into the trained machine learning model.

16. The electronic device according to claim 1,
wherein the element relationship indicates a hierarchical structure having a first level hierarchy and a second level hierarchy positioned below the first level hierarchy, the first level hierarchy including at least one of the one or more first subjects, the second level hierarchy including at least one of the one or more second subjects.

17. The electronic device according to claim 1,
wherein at least one of the first format and the second format is a data format for image data.

18. The electronic device according to claim 1,
wherein at least one of the first format and the second format is a data format representing a machine learning prompt.

19. The electronic device according to claim 1,
wherein the first format is a format for image data and the second format is a data format representing a machine learning prompt.

20. The electronic device according to claim 1,
wherein the first format is identical to the second format.

21. The electronic device according to claim 1,
wherein the first input data is image data, the image data representing an image of the element relationship among the plurality of elements,
wherein the second input data specifies the first condition for the one or more settings for the one or more second subjects represented in the image;
wherein the second condition further includes a requirement that that the subject-setting relationship indicates that each of the one or more second subjects represented in the image is associated with the corresponding one of the one or more recommended setting datasets.
